(19) United States
(12) Patent Application Publication
(10) Pub. No.: US 2026/0031283 A1
(43) Pub. Date: Jan. 29, 2026

(54) POWER TOOL

(71) Applicant: Nanjing Chervon Industry Co., Ltd., Nanjing (CN)

(72) Inventors: Yang Li, Nanjing (CN); Chengxin Pan, Nanjing (CN)

(21) Appl. No.: 19/270,557

(22) Filed: Jul. 16, 2025

(30) Foreign Application Priority Data
Jul. 29, 2024 (CN) 202421800557.9
Jul. 29, 2024 (CN) 202421812464.8

(51) Int. Cl. H01H 9/06; B25F 5/02; B27B 17/00; H01H 3/20

(52) U.S. Cl. CPC H01H 9/06; B25F 5/02; B27B 17/00; H01H 3/20; H01H 2231/048; H01H 2300/024

(57) ABSTRACT

A power tool includes a tool body, a grip, a trigger, a locking switch, and a locking retainer. The locking retainer is configured to apply a locking force to the locking switch to keep the locking switch in the locking state. During a process in which the locking switch is operated to switch from the locking state to the unlocking state, the locking force changes from large to small.

### RELATED APPLICATION INFORMATION

This application claims the benefit under 35 U.S.C. § 119 (a) of Chinese Patent Application No. CN 202421800557.9, filed on Jul. 29, 2024, and Chinese Patent Application No. CN 202421812464.8 filed on Jul. 29, 2024, which applications are incorporated herein by reference in their entireties.

### BACKGROUND

A chainsaw is a common handheld garden tool and is widely used with the increase in private and public greening areas. Currently, most chainsaws use electricity as a power source. A motor inside a chainsaw may drive a chain to rotate around a guide plate and then cause interlaced L-shaped blades on the chain to cut wood or branches.

Currently, the chainsaw typically has a trigger switch on a handle that is held by a user. However, when the chainsaw is used, a case where the trigger switch is pressed unintentionally may occur, resulting in abnormal activation of the chainsaw when the user only needs to hold the chainsaw rather than use the chainsaw, causing danger. Therefore, a safety switch is provided in the related art to prevent accidental actuation of the trigger switch. However, the safety switch must meet the safety regulations requiring an actuation force greater than or equal to 20 N, that is, the safety switch can only be pressed under the action of a force greater than or equal to 20 N, resulting in a poor user experience.

### SUMMARY

A power tool includes: a tool body; a grip; a trigger that is operable and mounted on the grip; and a locking switch that is operable and mounted on the grip, where the locking switch has a locking state in which the locking switch prohibits the trigger from being triggered and an unlocking state in which the locking switch allows the trigger to be triggered; and a locking retainer configured to apply a locking force to the locking switch to keep the locking switch in the locking state. During a process in which the locking switch is operated to switch from the locking state to the unlocking state, the locking force changes from large to small.

In some examples, the force applied by the locking retainer to the locking switch continues decreasing in the case where the locking switch is continuously operated.

In some examples, the locking force is capable of resisting an instantaneous force of at least 20 N.

In some examples, the locking retainer includes a magnetic member.

In some examples, the locking retainer includes a first magnetic member mounted on the grip and a second magnetic member mounted on the locking switch.

In some examples, the locking switch includes a first mounting portion rotatably mounted in the grip.

In some examples, the locking switch further includes a second mounting portion, the power tool further includes an elastic member, an end of the elastic member is connected to the second mounting portion, and the other end of the elastic member is mounted inside the grip.

In some examples, the locking switch further includes a third mounting portion for mounting the second elastic member.

In some examples, the trigger includes a first locking portion configured to be interlockable with a second locking portion on the locking switch.

In some examples, the locking switch and the trigger are disposed at two opposite positions on the grip, respectively.

A power tool includes: a tool body; a grip; a trigger that is operable and mounted on the grip; and a locking switch that is operable and mounted on the grip, where the locking switch has a locking state in which the locking switch prohibits the trigger from being triggered and an unlocking state in which the locking switch allows the trigger to be triggered; and a locking retainer configured to apply a locking force to the locking switch to keep the locking switch in the locking state. The locking force is capable of resisting an instantaneous force of at least 20 N.

A power tool includes: a tool body; a grip; a trigger that is operable, mounted on the grip, and at least partially exposed outside the grip; and a locking switch that is operable, mounted on the grip, and at least partially exposed outside the grip, where a part of the locking switch exposed outside the grip is configured in a fin shape, and the locking switch has a locking state in which the locking switch is interlocked with the trigger. In the case where the locking switch is operated along a first direction X basically parallel to the extension direction of the grip, the locking switch is switched from the locking state to a pre-unlocking state. In the case where the locking switch is operated along a second direction Y, the locking switch is switched from the pre-unlocking state to an unlocking state, and the trigger is allowed to be operated.

In some examples, the second direction Y is basically perpendicular to the first direction X.

In some examples, in the case where the locking switch is operated along the first direction X by a movement distance of greater than or equal to 0.5 mm, the locking switch is switched from the locking state to the pre-unlocking state.

In some examples, the trigger includes: a first locking portion configured to be interlockable with a second locking portion on the locking switch; and an accommodation cavity configured to accommodate the second locking portion when the locking switch moves along the second direction Y.

In some examples, the locking switch includes: a first mounting portion configured to be movable and mounted inside the grip; and a second mounting portion configured to be movable and mounted inside the grip.

In some examples, the first mounting portion is configured to enable the locking switch to be operated along the first direction X and to be operated along the second direction (Y).

In some examples, a limiting guide portion is provided in the grip, and the first mounting portion is mounted to the limiting guide portion.

In some examples, the first mounting portion is a hole-shaped structure, the limiting guide portion is located in the hole-shaped structure, and the dimension of the hole-shaped structure along the first direction X is greater than the dimension of the limiting guide portion along the first direction X.

In some examples, the power tool further includes an elastic member, an end of the elastic member is connected to the second mounting portion, and the other end of the elastic member is mounted inside the grip.

In some examples, the locking switch and the trigger are disposed at two opposite positions on the grip, respectively.

### BRIEF DESCRIPTION OF THE DRAWINGS

FIG. 1 is a structural view of a chainsaw according to the present application.

FIG. 2 is a structural view of a grip when a locking switch is in a locking state according to example one of the present application.

FIG. 3 is a structural view of a grip when a locking switch is in a pre-unlocking state according to example one of the present application.

FIG. 4 is a structural view of a grip when a locking switch is in an unlocking state according to example one of the present application.

FIG. 5 is a structural view of a first locking portion and a second locking portion when a locking switch is in a locking state according to example one of the present application.

FIG. 6 is a structural view of a first locking portion and a second locking portion when a locking switch is in a pre-locking state according to example one of the present application.

FIG. 7 is a structural view of a grip when a locking switch is in a locking state according to example two of the present application.

FIG. 8 is a structural view of a grip when a locking switch is in an unlocking state according to example two of the present application.

FIG. 9 is a structural view of a grip when a first locking switch and a second locking switch are each in a locking state according to example three of the present application.

FIG. 10 is a structural view of a grip when a first locking switch and a second locking switch are each in an unlocking state according to example three of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

The present application provides a power tool. The power tool includes a functional element to implement a function. The power tool is a chainsaw 100, and the functional element of the chainsaw 100 is a chain 12.

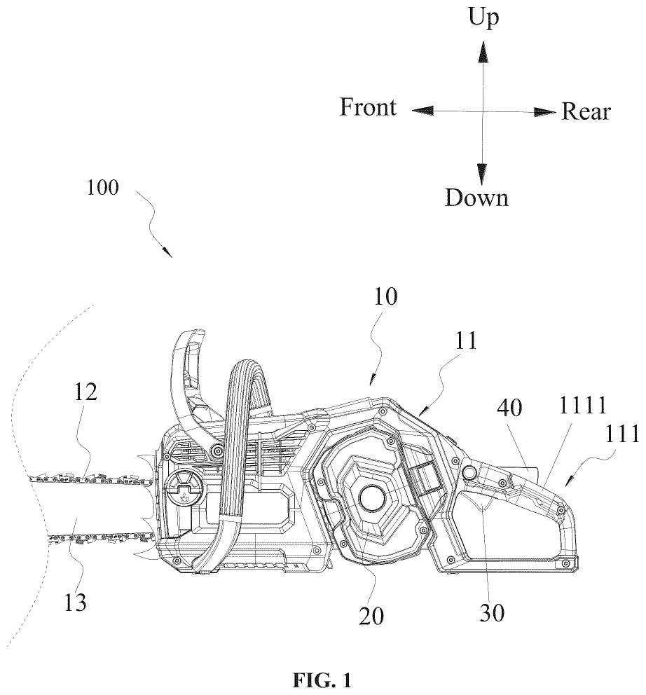

To clearly illustrate the technical solutions of the present application, the up and down direction and the front and rear direction as shown in FIG. 1 are defined.

As shown in FIG. 1, the chainsaw 100 includes a tool body 10 and a power supply device 20. The power supply device 20 is used for providing energy to the tool body 10. The tool body 10 includes a housing 11, a chain 12, a guide plate 13, and a motor (not shown in the figure). An end of the guide plate 13 is supported on the housing 11, and the other end of the guide plate 13 extends forward from the housing 11 along the longitudinal direction of the housing 11, that is, along the front and rear direction. The guide plate 13 supports and guides the chain 12. The motor is disposed in the accommodation space formed by the housing 11. The motor is the prime mover of the chainsaw 100. The motor converts the electrical energy provided by the power supply device 20 into the mechanical energy for the rotation of the output shaft and then drives the chain 12 directly or indirectly through a transmission assembly to make the chain 12 implement a cutting function around the guide plate 13.

The power supply device 20 includes at least one battery pack detachably connected to the housing 11 so that the user can replace the battery pack conveniently, thereby extending the service life of the chainsaw 100. In some examples, the housing 11 is formed with an accommodation portion for accommodating the battery pack, and the battery pack is detachably mounted in the accommodation portion.

The housing 11 forms a handle 111 extending along the front and rear direction, and the handle 111 forms a grip 1111 for the user to hold. The handle 111 is located behind the battery pack in the front and rear direction so that the user holds the handle 111 conveniently, which is in conformity with ergonomics.

A trigger 30 is provided on the grip 1111, and at least part of the trigger 30 is outside the grip 1111. The trigger 30 is used for controlling the start and stop of the chainsaw 100. The trigger 30 is reasonably disposed at a position so that the trigger 30 is convenient for the user to operate, thereby improving user operation comfort.

A locking switch 40 is further provided on the grip 1111. The locking switch 40 is a safety switch for preventing the trigger 30 from being accidentally actuated.

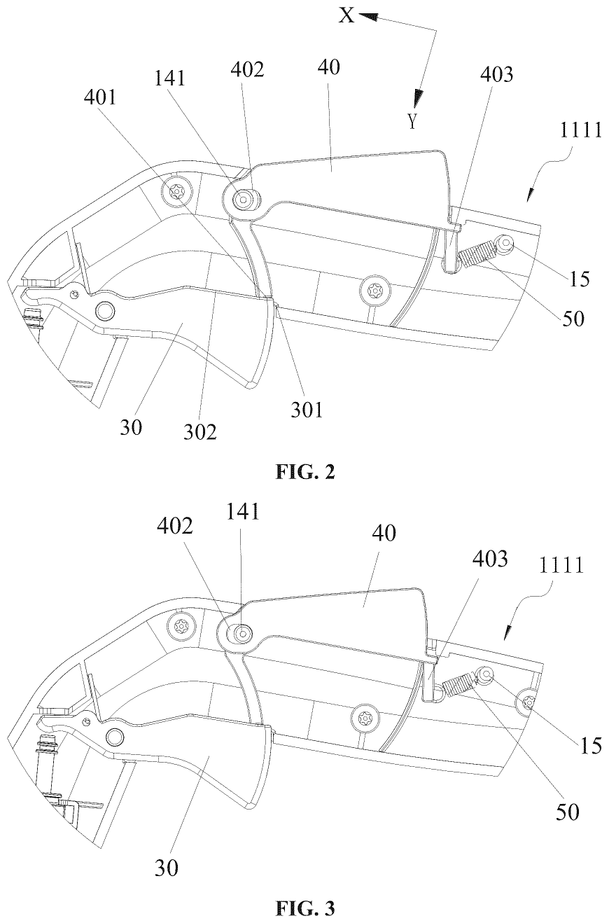

In some examples, as shown in FIGS. 2 to 8, one locking switch 40 is provided, and the locking switch 40 and the trigger 30 are disposed at two opposite positions on the grip 1111, respectively.

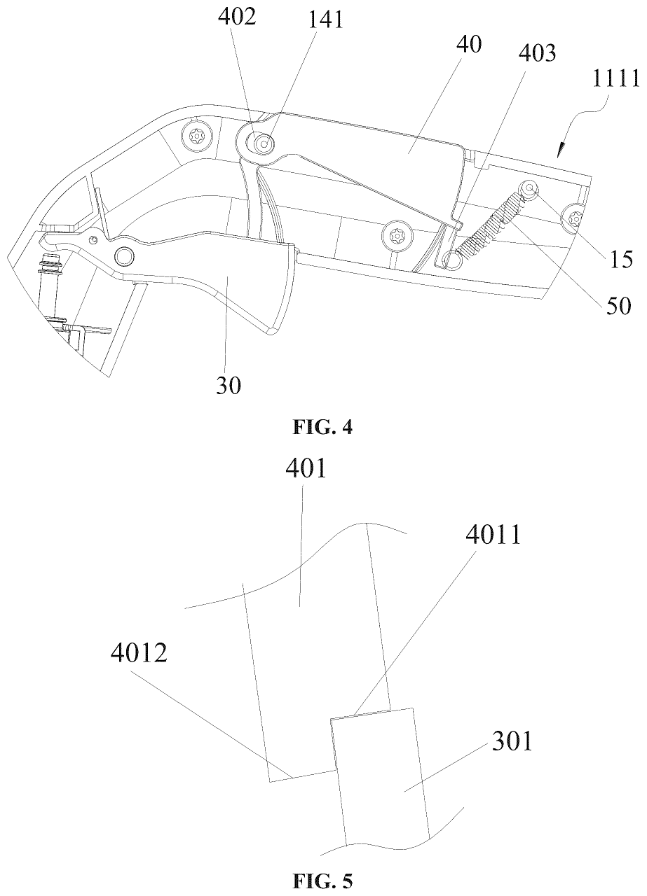

In some examples, as shown in FIGS. 2 to 4, the locking switch 40 has a locking state, a pre-unlocking state, and an unlocking state. Referring to FIG. 2, when the locking switch 40 is in the locking state, the locking switch 40 is interlocked with the trigger 30, and the trigger 30 is not allowed to be operated at this time. Referring to FIG. 3, in the case where the locking switch 40 is operated along the first direction X basically parallel to the extension direction of the grip 1111, the locking switch 40 is switched from the locking state to the pre-unlocking state, and the trigger 30 is still not allowed to be operated. Referring to FIG. 4, in the case where the locking switch 40 is operated along the second direction Y, the locking switch 40 is switched from the pre-unlocking state to the unlocking state, and the trigger 30 is allowed to be operated at this time. In some examples, the second direction Y is basically perpendicular to the first direction X.

By setting the pre-unlocking state between the locking state and the unlocking state, the locking switch 40 needs to be pushed to the pre-unlocking state along the first direction X before the locking switch 40 can be pressed to the unlocking state along the second direction Y so that the locking switch 40 in the locking state cannot be pressed, thereby not only meeting the safety regulations requiring an actuation force greater than or equal to 20 N but also ensuring a better user experience. In some examples, in the case where the locking switch 40 is operated along the first direction X by a movement distance of greater than or equal to 0.5 mm, the locking switch 40 is switched from the locking state to the pre-unlocking state.

With continued reference to FIGS. 2 to 4, the locking switch 40 is at least partially exposed outside the grip 1111, and the part of the locking switch 40 exposed outside the grip 1111 is configured in a fin shape to satisfy the user's usage habits.

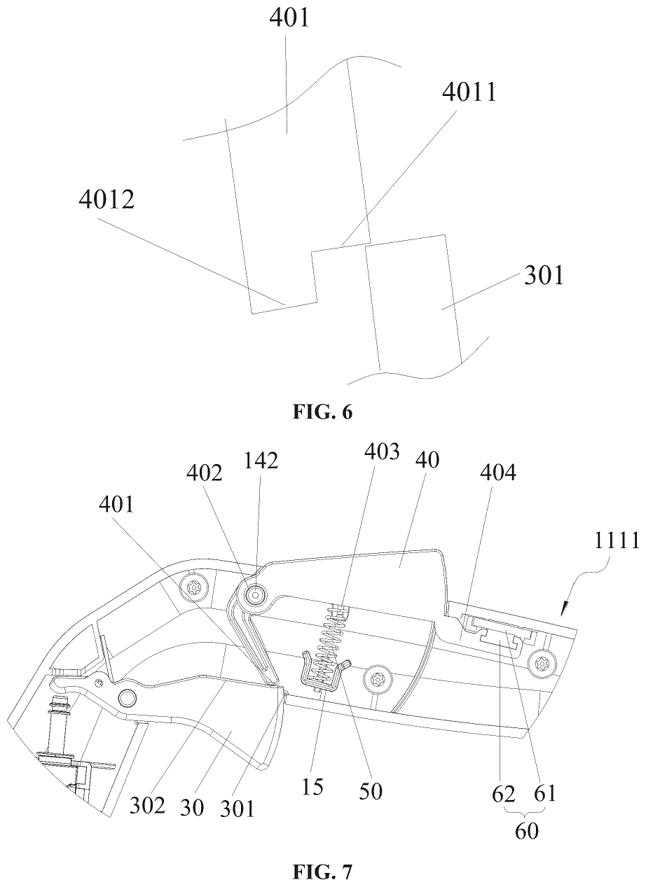

With continued reference to FIGS. 2 to 4 and in conjunction with FIGS. 5 and 6, the trigger 30 includes a first locking portion 301 and an accommodation cavity 302, and the first locking portion 301 is configured to be interlockable with a second locking portion 401 on the locking switch 40. Specifically, when the locking switch 40 is in the locking state, the first locking portion 301 is interlocked with the second locking portion 401. In some examples, the second locking portion 401 has a step structure which includes a first step surface 4011 and a second step surface 4012. Along the second direction Y (that is, the up and down direction of the chainsaw 100), the second step surface 4012 is closer to the trigger 30 than the first step surface 4011, that is, the second step surface 4012 is lower than the first step surface 4011. Referring to FIG. 5, when the locking switch 40 is in the locking state, the first step surface 4011 abuts against the upper end surface of the first locking portion 301, and the connecting surface between the first step surface 4011 and the second step surface 4012 abuts against the side end surface of the first locking portion 301. Referring to FIG. 6, when the locking switch 40 is operated along the first direction X, the second locking portion 401 moves a distance along the first direction X correspondingly. When the second locking portion 401 moves, the first step surface 4011 always keeps in contact with the first locking portion 301. When the locking switch 40 is switched to the pre-unlocking state, the edge of the first step surface 4011 is in contact with the first locking portion 301. At this time, the trigger 30 still cannot be triggered under the restriction of the first step surface 4011. When the locking switch 40 is operated along the second direction Y, the first step surface 4011 is disengaged from the first locking portion 301, that is, the interlocking between the first locking portion 301 and the second locking portion 401 is released, the second locking portion 401 is accommodated in the accommodation cavity 302 of the trigger, and the trigger 30 can be triggered at this time. Of course, the interlocking form between the first locking portion 301 and the second locking portion 401 is not limited thereto.

With continued reference to FIGS. 2 to 4, the locking switch 40 includes a first mounting portion 402 and a second mounting portion 403. The first mounting portion 402 is movable and mounted inside the grip 1111, and the second mounting portion 403 is movable and mounted inside the grip 1111. The first mounting portion 402 is used for enabling the locking switch 40 to be operated along the first direction X and to be operated along the second direction Y. In some examples, the first mounting portion 402 is a hole-shaped structure, a limiting guide portion 141 is disposed in the grip 1111, the limiting guide portion 141 is located in the hole-shaped structure, and the dimension of the hole-shaped structure along the first direction X is greater than the dimension of the limiting guide portion 141 along the first direction X. In this manner, the locking switch 40 can move along the first direction X under the guidance of the hole-shaped structure and the limiting guide portion 141, and the movement distance of the locking switch 40 is determined by the dimension of the hole-shaped structure along the first direction X; and the locking switch 40 can rotate around the limiting guide portion 141 so that the locking switch 40 can be operated along the second direction Y. The second mounting portion 403 is used for mounting an elastic member 50. An end of the elastic member 50 is connected to the second mounting portion 403, and the other end of the elastic member 50 is mounted on an elastic member mounting portion 15 inside the grip 1111. The elastic member 50 is used for providing the locking switch 40 with a force required for resetting. When the locking switch 40 is operated along the first direction X and the second direction Y, the elastic member 50 is elastically deformed. When the operating force along the first direction X and the second direction Y is released from the locking switch 40, the locking switch 40 is reset to the locking state under the action of the restoring force of the elastic member 50.

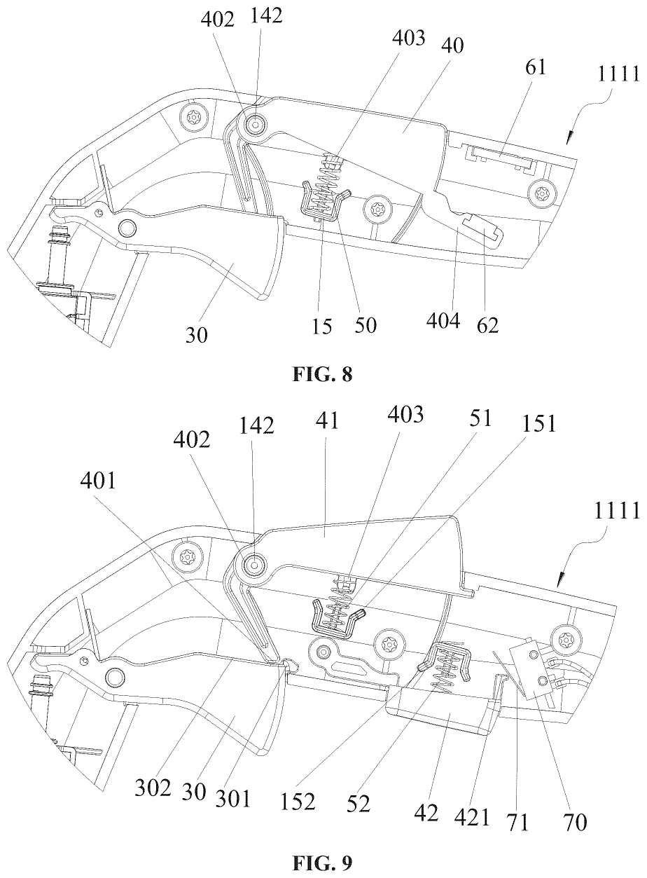

In some examples, as shown in FIGS. 7 and 8, the locking switch 40 has only the locking state and the unlocking state. Referring to FIG. 7, when the locking switch 40 is in the locking state, the locking switch 40 is interlocked with the trigger 30, and the trigger 30 is not allowed to be operated at this time. Referring to FIG. 8, when the locking switch 40 is in the unlocking state, the interlocking between the locking switch 40 and the trigger 30 is released, and the trigger 30 is allowed to be operated at this time. Furthermore, a locking retainer 60 configured to apply a locking force to the locking switch 40 to keep the locking switch 40 in the locking state is included. During a process in which the locking switch 40 is operated to switch from the locking state to the unlocking state, the locking force changes from large to small. By providing the locking retainer 60, the locking switch 40 can only be pressed after overcoming the locking force, thereby meeting safety regulations. In some examples, the locking force is capable of resisting an instantaneous force of at least 20 N, that is, an instantaneous force during safety regulation testing. In addition, during the process in which the locking switch 40 is operated to switch from the locking state to the unlocking state, the locking force changes from large to small, thereby ensuring a better user experience.

The force applied by the locking retainer 60 to the locking switch 40 continues decreasing in the case where the locking switch 40 is continuously operated. In some examples, the locking retainer 60 includes a magnetic member, the magnetic member may be mounted to the grip 1111, and at least the part of the locking switch 40 opposite to the magnetic member is made of magnetic material; or the magnetic member may be mounted to the locking switch 40, and at least the part of the grip 1111 opposite to the magnetic member is made of magnetic material. In some examples, with continued reference to FIGS. 7 and 8, the locking retainer 60 includes a first magnetic member 61 mounted on the grip 1111 and a second magnetic member 62 mounted on the locking switch 40, and the first magnetic member 61 and the second magnetic member 62 attract each other to apply a locking force to the locking switch 40.

With continued reference to FIGS. 7 and 8, the trigger 30 includes the first locking portion 301 and the accommodation cavity 302, and the first locking portion 301 is configured to be interlockable with the second locking portion 401 on the locking switch 40. Specifically, when the locking switch 40 is in the locking state, the first locking portion 301 is interlocked with the second locking portion 401. The accommodation cavity 302 is configured to accommodate the second locking portion 401 when the locking switch 40 is operated and pressed (moved along the second direction Y).

With continued reference to FIGS. 7 and 8, the locking switch 40 includes a first mounting portion 402, a second mounting portion 403, and a third mounting portion 404. The first mounting portion 402 is movable and mounted inside the grip 1111, the second mounting portion 403 is movable and mounted inside the grip 1111, and the third mounting portion 404 is movable and mounted inside the grip 1111. The first mounting portion 402 is used for enabling the locking switch 40 to be operated and pressed (that is, operated along the second direction Y). In some examples, the first mounting portion 402 is a hole-shaped structure, a rotating support portion 142 is disposed in the grip 1111, the hole-shaped structure is rotatably connected to the rotating support portion 142, and when the locking switch 40 is operated and pressed, the locking switch 40 rotates around the rotating support portion 142. The second mounting portion 403 is used for mounting an elastic member 50. An end of the elastic member 50 is connected to the second mounting portion 403, and the other end of the elastic member 50 is mounted on an elastic member mounting portion 15 inside the grip 1111. The elastic member 50 is used for providing the locking switch 40 with a force required for resetting. The third mounting portion 404 is used for mounting the second magnetic member 62. In some examples, a mounting groove is disposed on the third mounting portion 404, and a part of the second magnetic member 62 is located in the mounting groove.

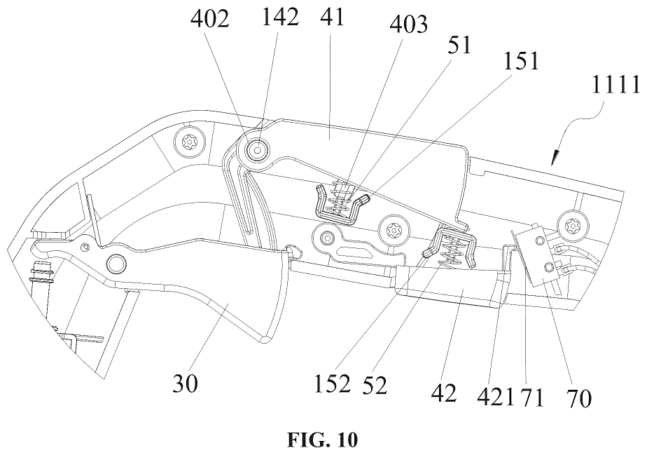

In some examples, as shown in FIGS. 9 and 10, two locking switches 40 are provided and include a first locking switch 41 and a second locking switch 42. The first locking switch 41 and the trigger 30 are disposed at two opposite positions on the grip 1111, respectively, and the second locking switch 42 and the trigger 30 are located on the same side of the grip 1111. The first locking switch 41 has a locking state in which the first locking switch 41 prohibits the trigger 30 from being triggered and an unlocking state in which the first locking switch 41 allows the trigger 30 to be triggered. The second locking switch 42 has a connection state in which the circuit of the power tool is turned on and a disconnection state in which the circuit of the power tool is turned off. When the first locking switch 41 is pressed, the trigger 30 can be operated. When the second locking switch 42 is pressed, an electronic switch 70 is turned on, and a control circuit in the power tool is turned on. After the first locking switch 41 and the second locking switch 42 are both pressed and the trigger 30 is operated, the motor is controlled to start through the electrical energy from the control circuit.

With continued reference to FIGS. 9 and 10, the trigger 30 includes the first locking portion 301 and the accommodation cavity 302, and the first locking portion 301 is configured to be interlockable with the second locking portion 401 on the first locking switch 41. Specifically, when the first locking switch 41 is in the locking state, the first locking portion 301 is interlocked with the second locking portion 401. The accommodation cavity 302 is configured to accommodate the second locking portion 401 when the first locking switch 41 is pressed (moved along the second direction Y).

The first locking switch 41 includes a first mounting portion 402 and a second mounting portion 403. The first mounting portion 402 is movable and mounted inside the grip 1111, and the second mounting portion 403 is movable and mounted inside the grip 1111. The first mounting portion 402 is used for enabling the locking switch 40 to be operated and pressed (that is, operated along the second direction Y). In some examples, the first mounting portion 402 is a hole-shaped structure, a rotating support portion 142 is disposed in the grip 1111, the hole-shaped structure is rotatably connected to the rotating support portion 142, and when the locking switch 40 is operated and pressed, the locking switch 40 rotates around the rotating support portion 142. The second mounting portion 403 is used for mounting a first elastic member 51. An end of the first elastic member 51 is connected to the second mounting portion 403, and the other end of the first elastic member 51 is mounted on a first elastic member mounting portion 151 inside the grip 1111. The first elastic member 51 is used for providing the first locking switch 41 with a force required for resetting.

With continued reference to FIGS. 9 and 10, the second locking switch 42 includes a fourth mounting portion and a trigger portion 421. The fourth mounting portion is used for mounting a second elastic member 52. An end of the second elastic member 52 is connected to the fourth mounting portion, and the other end of the second elastic member 52 is mounted on a second elastic member mounting portion 152 inside the grip 1111. The second elastic member 52 is used for providing the second locking switch 42 with a force required for resetting. The trigger portion 421 is used for triggering a switch portion 71 on the electronic switch 70.

The basic principles, main features, and advantages of the present application are shown and described above. It is to be understood by those skilled in the art that the preceding examples do not limit the present application in any form, and any technical solutions obtained through equivalent substitutions or equivalent transformations are within the scope of the present application.

1. A power tool, comprising:
a tool body;
a grip;
a trigger that is operable and mounted on the grip;
a locking switch that is operable and mounted on the grip, the locking switch having a locking state in which the locking switch prohibits the trigger from being triggered and an unlocking state in which the locking switch allows the trigger to be triggered; and
a locking retainer configured to apply a locking force to the locking switch to keep the locking switch in the locking state, wherein, during a process in which the locking switch is operated to switch from the locking state to the unlocking state, the locking force changes from large to small.

2. The power tool of claim 1, wherein the force applied by the locking retainer to the locking switch continues decreasing in a case where the locking switch is continuously operated.

3. The power tool of claim 1, wherein the locking force is capable of resisting an instantaneous force of at least 20 N.

4. The power tool of claim 1, wherein the locking retainer comprises a magnetic member.

5. The power tool of claim 1, wherein the locking retainer comprises a first magnetic member mounted on the grip and a second magnetic member mounted on the locking switch.

6. The power tool of claim 1, wherein the locking switch comprises a first mounting portion rotatably mounted in the grip.

7. The power tool of claim 1, wherein the locking switch further comprises a second mounting portion, the power tool further comprises an elastic member, an end of the elastic member is connected to the second mounting portion, and another end of the elastic member is mounted inside the grip.

8. The power tool of claim 5, wherein the locking switch further comprises a third mounting portion for mounting the second elastic member.

9. The power tool of claim 1, wherein the trigger comprises a first locking portion configured to be interlockable with a second locking portion on the locking switch.

10. The power tool of claim 1, wherein the locking switch and the trigger are disposed at two opposite positions on the grip, respectively.

11. A power tool, comprising:
a tool body;
a grip;
a trigger that is operable and mounted on the grip;
a locking switch that is operable and mounted on the grip, the locking switch having a locking state in which the locking switch prohibits the trigger from being triggered and an unlocking state in which the locking switch allows the trigger to be triggered; and
a locking retainer configured to apply a locking force to the locking switch to keep the locking switch in the locking state, wherein the locking force is capable of resisting an instantaneous force of at least 20 N.

12. The power tool of claim 11, wherein the locking retainer comprises a magnetic member.

13. The power tool of claim 11, wherein the locking retainer comprises a first magnetic member mounted on the grip and a second magnetic member mounted on the locking switch.

14. The power tool of claim 11, wherein the locking switch comprises a mounting portion rotatably mounted in the grip.

15. The power tool of claim 11, wherein the locking switch further comprises a first mounting portion, the power tool further comprises an elastic member, an end of the elastic member is connected to the first mounting portion, and another end of the elastic member is mounted inside the grip.

16. The power tool of claim 15, wherein the locking switch further comprises a second mounting portion for mounting the clastic member.

17. The power tool of claim 11, wherein the trigger comprises a first locking portion configured to be interlockable with a second locking portion on the locking switch.

18. The power tool of claim 11, wherein the locking switch and the trigger are disposed at two opposite positions on the grip, respectively.
